(19) United States
(12) Patent Application Publication
(10) Pub. No.: US 2009/0164767 A1
(43) Pub. Date: Jun. 25, 2009

(54) METHODS AND SYSTEMS FOR GENERATING AVAILABILITY MANAGEMENT FRAMEWORK (AMF) CONFIGURATIONS

(75) Inventors: Ali Kanso, Montreal (CA); Maria Toeroe, Montreal (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 11/961,849

(22) Filed: Dec. 20, 2007

(51) Int. Cl. G06F 15/177

(52) U.S. Cl. 713/1

(57) ABSTRACT

Techniques for generating a system model for use by an availability management function (AMF) are described. Inputs are received, processed and mapped into outputs which are further processed into a configuration file in an Information Model Management (IMM) Service external Markup Language (XML) format which can be used as a system model by an AMF.

### TECHNICAL FIELD

The present invention generally relates to high availability (HA) systems (hardware and software) and, more particularly, to HA systems managed by an Availability Management Framework (AMF).

### BACKGROUND

High availability systems (also known as HA systems) are systems that are implemented primarily for the purpose of improving the availability of services which the systems provide. Availability can be expressed as a percentage of time during which a system or service is “up”. For example, a system designed for 99.999% availability (so called “five nines” availability) refers to a system or service which has a downtime of only about 0.44 minutes/month or 5.26 minutes/year.

High availability systems provide for a designed level of availability by employing redundant nodes, which are used to provide service when system components fail. For example, if a server running a particular application crashes, an HA system will detect the crash and restart the application on another, redundant node. Various redundancy models can be used in HA systems. For example, an N+1 redundancy model provides a single extra node (associated with a number of primary nodes) that is brought online to take over the role of a node which has failed. However, in situations where a single HA system is managing many services, a single dedicated node for handling failures may not provide sufficient redundancy. In such situations, an N+M redundancy model, for example, can be used wherein more than one (M) standby nodes are included and available.

As HA systems become more commonplace for the support of important services such file sharing, internet customer portals, databases and the like, it has become desirable to provide standardized models and methodologies for the design of such systems. For example, the Service Availability Forum (SAF) has standardized application interface services (AIS) to aid in the development of portable, highly available applications. As shown in the conceptual architecture stack of FIG. 1, the AIS 10 is intended to provide a standardized interface for the HA middleware 16 and supports HA applications 14. As described below, each set of AIS functionality is associated with an operating system 20 and a hardware platform 22. The reader interested in more information relating to the AIS standard specification is referred to Application Interface Specifications (AIS), Release 5, which is available at www.saforum.org, the disclosure of which is incorporated here by reference.

Of particular interest for the present application is the Availability Management Framework (AMF), which is a software entity defined within the AIS specification. According to the AIS specification, the AMF is a standardized mechanism for providing service availability by coordinating redundant resources within a cluster to deliver a system with no single point of failure. The AMF provides a set of application program interfaces (APIs) which determine, among other things, the states of components within a cluster and the health of those components. The components are also provided with the capability to query the AMF for information about their state. An application which is developed using the AMF APIs and following the AMF system model leaves the burden of managing the availability of its services to the AMF. Thus, such an application does not need to deal with dynamic reconfiguration issues related to component failures, maintenance, etc.

As specified in the foregoing standards, each AMF (software entity) provides availability support for a single logical cluster that consists of a number of cluster nodes and components an example of which is shown in FIG. 2. Therein, a first cluster A includes its own AMF 24, two AMF nodes 26, 28 and four AMF components 30-36. Similarly, a second cluster B has its own AMF 38, two AMF nodes 40, 42 and four AMF components 44-50. The components 30-36 and 44-50 each represent a set of hardware and software resources that are being managed by the AMFs 24 and 38, respectively. In a physical sense, components are realized as processes of an HA application. In this example, the nodes 26, 28, 40, 42 each represent a logical entity which corresponds to a physical node however in other examples the ratio between physical nodes and logical entities could be a 1:n ratio.

The AIS standard also defines a service unit (SU) as a logical entity that aggregates a set of components, thereby combining their individual functionalities to provide a higher level service. A service unit can contain any number of components, but a particular component can be configured in only one service unit. Since each component is always enclosed in a service unit, from the AMF's perspective, the service unit can be considered the incremental unit of redundancy in the sense that it is the smallest logical entity that can be organized into groups in a redundant manner to provide and protect the service instances.

A service group (SG) is defined within the AIS standard as a logical entity that groups one or more SUs in order to provide service availability for a particular set of service instances according to a particular redundancy model. The AIS standard also defines an application as being a logical entity that contains one or more SGs. An application combines the individual functionalities of the constituent service groups to provide a higher level of service. From a software administration point of view, this grouping into an application reflects the set of SUs and contained components that are delivered as a consistent set of software packages within the AMF environment. Within this environment, by introducing the software management framework (SMF), the AMF was extended with types that allow the characterization of software developed for SAF systems, e.g., software which is used to provide HA services managed by the AMF.

This software can typically be deployed in different configurations depending on, for example, the characteristics of the system it is deployed on, the number of nodes and their characteristics, the capabilities of the AMF implementation and the requirements put on the provided services. Thus, a software vendor can describe their software such that it would allow for the widest possible usage by describing various AMF related characteristics of the software. Based on this a system integrator has to produce a particular configuration for the system the software is deployed on. However, none of the current SAF specifications define how to generate the information model, i.e., the configuration to be used by an AMF implementation in a particular system for a particular application. Therefore, one option for creating an information model would be to create it manually. Considering the potential for an AMF configuration file to have hundreds if not thousands of lines of code to be properly defined, creating a configuration file in a manual manner will be time consuming and prone to errors.

### SUMMARY

Accordingly, it would be desirable to provide systems and methods automating the generation of configurations for an AMF system or process.

Systems and methods according to the present invention address this need and others by automating the generation of configurations for an AMF system or process.

According to an exemplary embodiment, a method for generating a configuration for an Availability Management Framework (AMF) includes: receiving inputs, associated with at least one service to be managed by the AMF and software used to provide the at least one service; processing the inputs to support the at least one service; and generating the configuration using the processed inputs.

According to another exemplary embodiment, a system includes: a node for supporting generation of a configuration for an Availability Management Framework (AMF); and a processor for generating the configuration for an AMF, including performing the functions of: receiving inputs, associated with at least one service to be managed by the AMF and software used to provide the at least one service; processing the inputs to support the at least one service; and generating the configuration using the processed inputs.

According to another exemplary embodiment, a computer-readable medium containing instructions which, when executed on a computer or processor, perform the steps of: receiving inputs, associated with at least one service to be managed by the AMF and software used to provide the at least one service; processing the inputs to support the at least one service; and generating the configuration using the processed inputs.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 illustrates a conceptual architecture stack associated with application interface services (AIS);

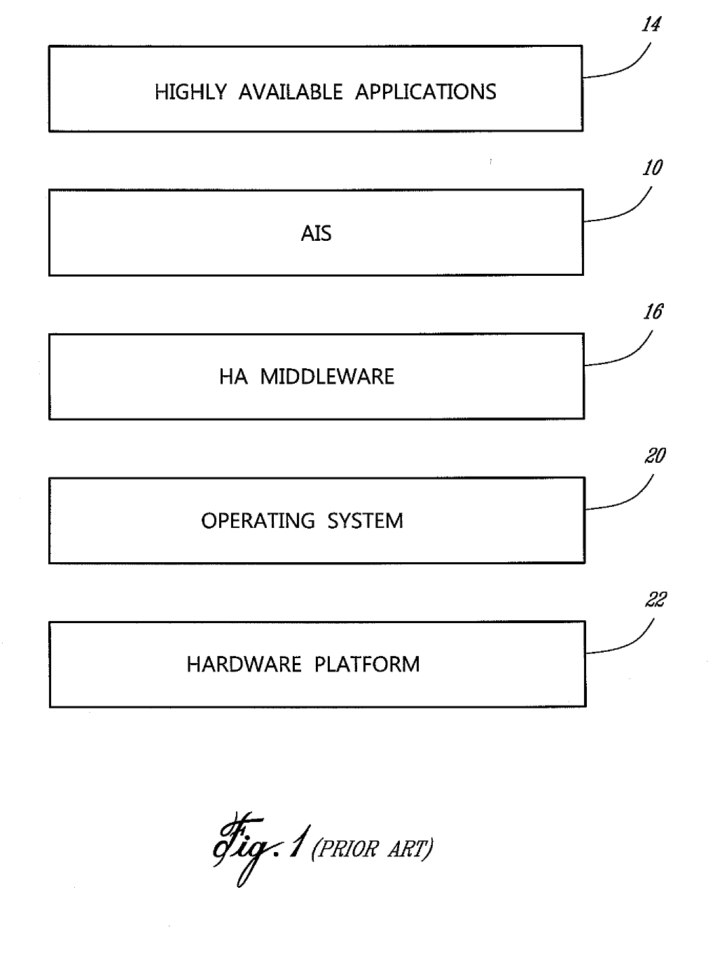

FIG. 2 illustrates an availability management framework (AMF) cluster architecture;

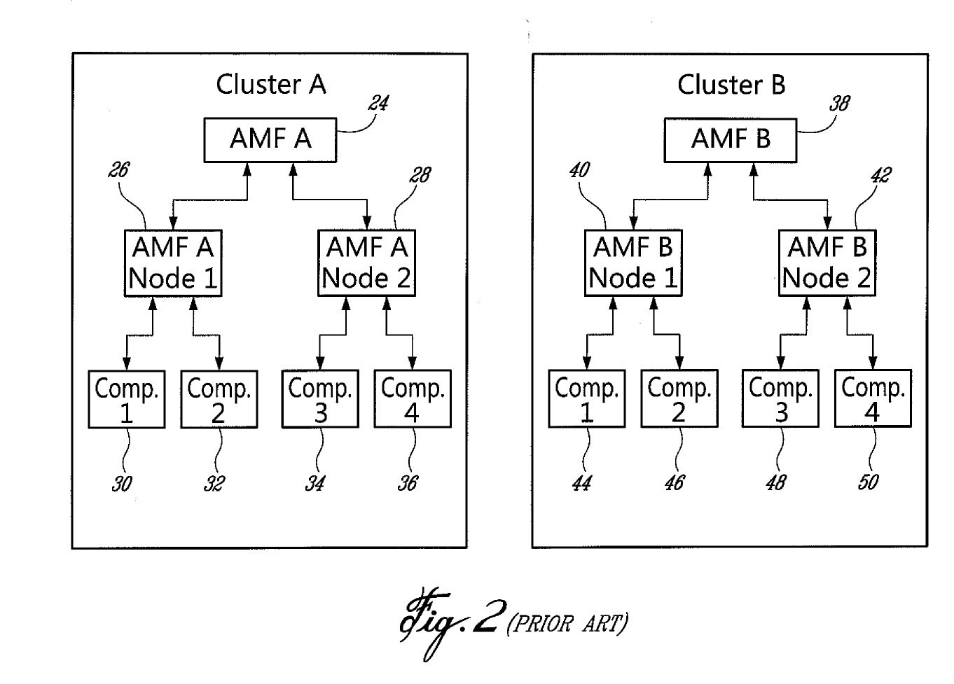

FIG. 3 shows an exemplary AMF managed system including service units and components;

FIG. 4(a) depicts a high level flowchart for generating an AMF configuration according to exemplary embodiments;

FIG. 4(b) shows processes that occur within an AMF configuration generator according to exemplary embodiments;

FIG. 5 is an illustration of component types according to exemplary embodiments;

FIG. 6 shows component service types associated with attributes according to exemplary embodiments;

FIG. 7 shows service types associated with component service types according to exemplary embodiments;

FIG. 8 illustrates service instance templates, component service instance templates and a node template according to exemplary embodiments;

FIG. 9 illustrates a service instance template and the output service instances and new service unit created according to exemplary embodiments;

FIG. 10 shows a newly created service group according to exemplary embodiments;

FIG. 11 depicts a node according to exemplary embodiments; and

FIG. 12 shows a flowchart for creating an AMF configuration file according to exemplary embodiments.

### DETAILED DESCRIPTION

The following description of the exemplary embodiments of the present invention refers to the accompanying drawings. The same reference numbers in different drawings identify the same or similar elements. The following detailed description does not limit the invention. Instead, the scope of the invention is defined by the appended claims.

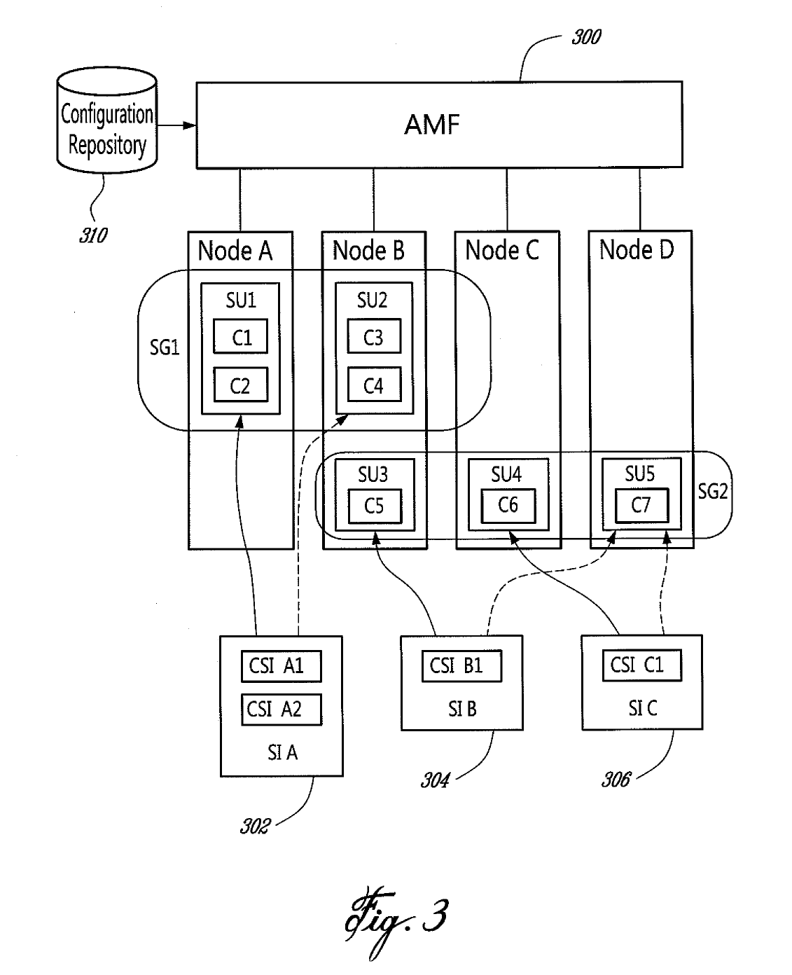

To provide some additional context for this discussion, consider an exemplary Availability Management Framework (AMF) controlled High Availability (HA) system as shown in FIG. 3. Therein, four nodes (A, B, C and D) are associated with two service groups (SG1 and SG2). A service group is a group of service units (SUs) which provide service availability for one or more service instances (SIs) of a particular service. For example, SG1 includes SU1 and SU2 which, in this example, support an instance of an e-mail service (hardware and software) and SG2 includes SU3, SU4 and SU5, which support two instances of a fax service (hardware and software). For the email service instance supported by SG1, SU1 is assigned to the active state and SU2 is assigned to the standby state.

Each of the exemplary service units in SG1 has two components associated therewith. A component is the smallest logical entity on which the AMF 300 performs error detection and isolation, recovery, and repair. Thus, a component typically includes all of the functions which cannot be clearly separated for error containment or isolation purposes. The component is also the logical entity that a portion of a workload is assigned within the provisioning of a service instance, e.g. the email service. Such a portion of the workload is called a component service instance (CSI). The email service instance SI A is composed of two component service instances CSI A1 and CSI A2. Each of these can be assigned to a component within a service unit. Components can further be grouped into protection groups which reflect the redundancy associated with provision of the component service instances. For example, components C1 and C3 can form a first protection group for CSI A1 and components C2 and C4 can form a second protection group for CSI A2, both of which are associated with the email service instance SI A. Thus if component C1 fails while being assigned active for CSI A1 and C3 assigned as standby, the AMF 300 could fail over CSI A1 to component C3 the active state and, similarly, if component C2 fails while being active for CSI A2, then the AMF 300 could fail over CSI A2 to component C4 the active state. At the time of the fail over of CSI A1, AMF 300 may switch over or may fail over CSI A2 as well so the entire service unit SU2 becomes assigned active for the entire service instance SI A.

Service group SG2 illustrates a slightly different configuration wherein two instances of a fax service are supported by three service units SU3, SU4 and SU5. For example, SU3 and SU4 could each be assigned the active state such that each supports one instance of the fax service, while SU5 could be assigned the standby state and operate as their redundant backup. In this case, components C5 and C7 would form one protection group associated with one of the two fax service instances SI B and within that protect component service instance CSI B1. Components C6 and C7 could form a second protection group to protect CSI C1 associated with the other SI C of the two fax service instances.

In the above described examples, service groups, service units and components can all considered to be logical entities associated with physical entities that perform work. These logical entities are assigned workloads in order to render the service, e.g., email or fax service. A component service instance (CSI) represents the workload that the AMF 300 can dynamically assign to a single component. Component service instances are grouped into a logical entity called a service instance (SI). A service instance aggregates all component service instances to be assigned to the individual components of the service unit in order for the service unit to provide a particular service, e.g., email or fax service. A service instance represents a single workload assigned to the entire service unit. As shown in FIG. 3, service instances are shown as well as their relationship with the components, service units and service groups on the four nodes. More specifically, for SIA 302, SU1 is assigned the active HA state and SU2 is assigned the standby HA state (as shown by the dashed connecting line). For SIA 302, two CSIs (A1 and A2) are assigned to components C1 and C3, and to C2 and C4, respectively. Regarding SIB 304, SU3 is assigned the active HA state and SU5 is assigned the standby state (as shown by the dashed connecting line). Similar comments apply towards SIC 306.

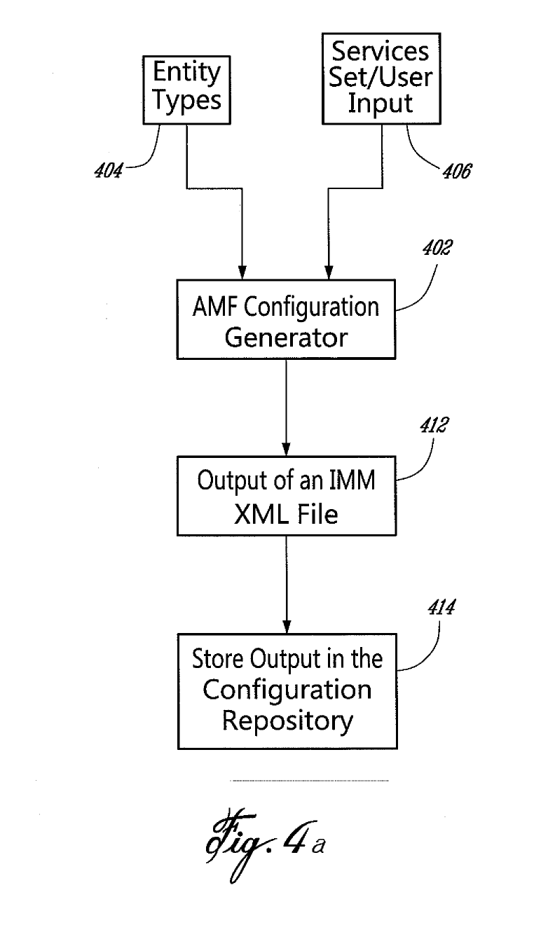

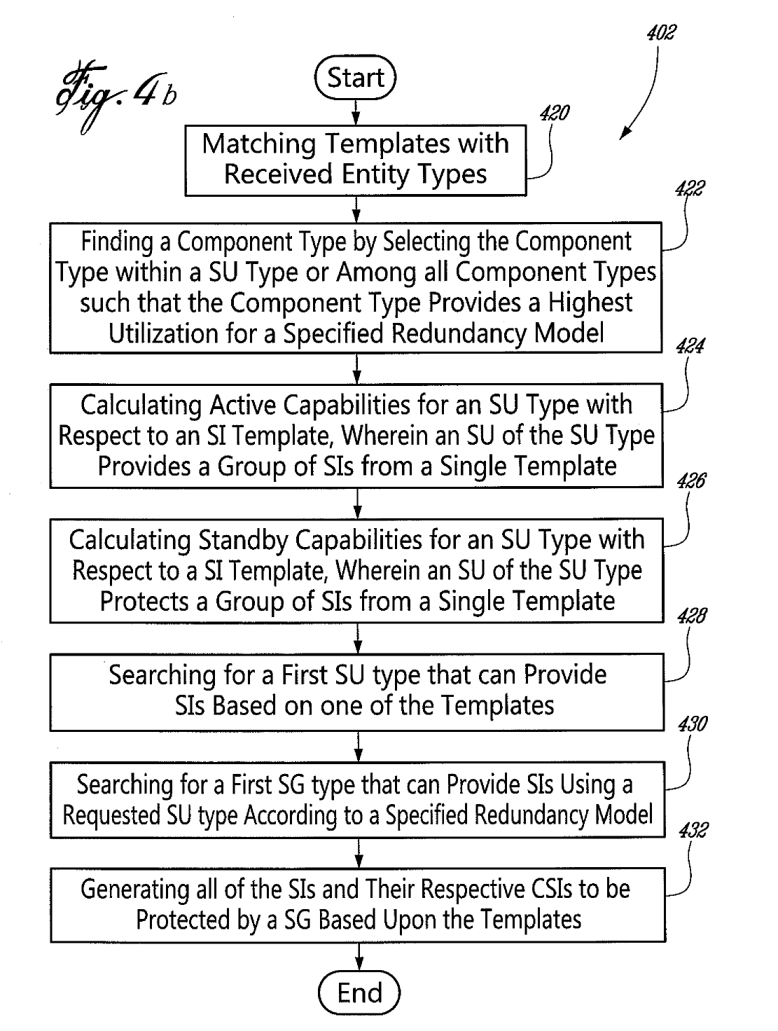

For an AMF software entity 300 to operate in the above described exemplary manner, the AMF software entity 300 needs to receive from a configuration repository 310 an input, file or system model which describes what is to be managed. In a Service Availability Forum (SAF) cluster the Information Model Management IMM typically serves as the configuration repository 310. According to one exemplary embodiment, such configuration information can take the form of an XML (eXternal Markup Language) file, however it will be appreciated that the particular form or format of the configuration input is not critical. According to exemplary embodiments, a high level method for generating the configuration input an AMF application will now be described with respect to FIG. 4(a). Initially an AMF Configuration Generator 402 receives inputs of entity types 404, e.g., as entity types files (ETFs) and services set/user input 406 to perform a mapping function which creates a system model for future use. This system model is output by the AMF Configuration Generator 402 in the form, for example, an XML file according to the SAF Information Model Management (IMM) Service XML schema 412. This output code in an IMM XML file 412 is then stored in the configuration repository 310 in step 414. These various inputs and steps will be described in more detail below.

The first exemplary input is entity types 404 which describe, for example, various AMF related characteristics associated with application software to be monitored by the AMF system. These entity types 404 are AMF entity types described in XML entity types files, as described by the SAF Software Management Framework (SMF) specification SAI-AIS-SMF-A.01.01 which is available at www.saforum.org, the disclosure of which is incorporated here by reference. From the SAF specifications, there are currently two mandatory AMF entity types that need to accompany any application software. These two entity types are the component types and their respective component service types. Other entity types may also be provided as inputs 404, however, they do not have to be present in an entity types file if the software implementation has no restrictions related to them.

The second exemplary type of input is the services set/user input 406. The services set/user input 406 typically includes information related to the services the site provides for which the AMF configuration is being created. In the AMF environment, the services set/user input 406 is a set of service instances in which each service instance is described by a set of component service instances as well as other desired user inputs, e.g., a number of nodes provided with the system providing the service or services to be monitored and the desired redundancy model. The services set/user input 406 is typically site specific. Similar to the methods described above with respect to FIG. 3, this exemplary method involves using SI templates. These SI templates describe a set of SIs that are protected by SGs of the same type. Within each SI template the CSIs are also defined via CSI templates. The SI templates are typically based on the service types provided as service set/user input 406 or by the entity types files. The service type determines the composing CS types and any limits for the number of component service instances that an SI of the service type may contain. Accordingly, the CSI templates are based on the CS types provided by the software and the user input needs to indicate which CS types are used from these and how many instances of them are desired for the composition of an SI of the particular SI template. An SI template also defines the number of SIs to be configured based on this template and their grouping to SGs. Additionally, the desired redundancy model is typically input by a user and included in the SI template. Another input typically received by the AMF Configuration Generator 402 from the services set/user input 406 is the number of nodes. The number of nodes input is used to assign the service units of the configuration to nodes according to different criteria (e.g. implement hardware redundancy, load balancing among cluster nodes, etc.) if necessary. This information may be provided as a user input to the AMF Configuration Generator 402, or collected from the target system by other SAF services.

These exemplary input entity types 404 and services set/user input 406 are received at the AMF Configuration Generator 402 where the inputs are processed to generate a system model for a specific AMF configuration. A general discussion of the configuration generation will now be provided followed by a detailed (but purely exemplary) pseudo-code implementation. References to the pseudo code implementation are priced in the text below in parentheses.

Initially the exemplary configuration generation method (generateConf method) begins by matching each received SI template with the entity types 404 provided. A suitable SU type is selected from among those in the received input set (findSUType method). This selection method checks the SU types for the capability of providing the desired service type that the SI template refers to. If there are such SU types available, then one is selected by matching the capabilities of the component types of the SU type for each of the component service types with the capabilities required for providing the specified component service type by the CSI templates (findCompType method) in the required redundancy mode required by the enclosing SI template. According to one exemplary embodiment, the selection method finds the SU type(s) that provide the CSI(s) with the minimum number of components, i.e., the selection criterion results in maximizing the utilization of each component in the configuration. However, other selection criterion can be used as desired.

For the case where the selection criterion results in no SU types found that provide the desired composition of CSIs, this exemplary configuration generator 402 can determine whether the available component types can be grouped in another manner to construct a new, desired SU type. This can occur as part of the findSUType and findCompType pseudo-code functions described below, i.e., the findCompType method adds an appropriate component type from the complete set of component types to the newly constructed SU type for each set of CSIs that needs to be protected. This determination as to whether new SU types may be constructed is typically based upon a user input, e.g., a yes or no input regarding whether the AMF Configuration Generator 402 is permitted to perform new SU type construction. If a no is submitted then only the submitted types will be used. If a yes is submitted, then the submitted SU types will preferably be used, however, if the submitted SU types are found to be insufficient, the AMF Configuration Generator 402 will have the option to attempt to create an appropriate SU type. Once an SU type is found or constructed, this exemplary method chooses an appropriate SG type from the available set of SG types based on the features defined by the user for the desired redundancy model in the SI template. If no such appropriate SG type is available, a new SG type is created using input parameters found within the SI template.

Upon completion of finding the appropriate entity types, the AMF Configuration Generator 402 generates the instances of these types (generateConf method) that can provide the desired services (createSis method). The configuration is populated so that both the active and the standby assignments of each SI protected by each SG can be satisfied. This is done by creating one SU with the required number of components so that the SU provides the required active and standby capabilities for all of the SIs and within them for all CSIs. Once all of the components of the first SU have been added, other SUs required by the redundancy model are copied from this first SU as desired for the HA environment to create a first SG. This procedure is then repeated for each SG necessary to protect all the service instances generated from an SI template in the configuration that is currently being created. Additionally, one exemplary method for creating this configuration uses equal ranking and equal load between all SUs. Alternatively, other exemplary methods can be used.

For example according to one exemplary embodiment, instead of using equal ranking and load, different ranks can be assigned to the different SUs within an SG. A global rank can be assigned as well as a per SI rank. If only the global rank is specified then for SIs this is the rank that would be used. According to another exemplary embodiment, other factors can be used in assigning rank such as, for example, SI load based upon different resource needs, e.g., a database application would be storage/memory intensive. Also a collaboration of different applications, or the opposite, could be considered. According to one exemplary embodiment, populating this configuration can be complemented by using a method that generates, based on the previously generated SI and CSI templates, all (or a desired portion) of the SI and CSIs respective attributes.

The exemplary processing described above with respect to the AMF Configuration Generator 402 will now be summarized as shown in the exemplary flowchart of FIG. 4(b). Initially, each received SI template is matched with the received entity types 404 in step 420. Matching also occurs in the follow on steps as needed. Processing then continues by finding a component type by selecting the component type within an SU type or among all component types (provided it is permitted to construct a new SU type) such that the component type provides a highest utilization for a specified redundancy model in step 422. Calculating required active capabilities for an SU type within an SG with respect to an SI template, wherein an SU of the SU type provides a group of SIs from a single template occurs in step 424. Similarly, calculating required standby capabilities for an SU type with respect to an SI template, wherein an SU of the SU type protects a group of SIs from a single template occurs in step 426. The Configuration Generator 402 then searches for a first SU type that can provide SIs based on one of the templates in step 428. This leads to searching for a first SG type that can provide SIs using a requested SU type according to a specified redundancy model in step 430. Once the necessary entity types have been identified the configuration generation proceeds with populating the configuration with the instances of these types. This begins with generating all of the SIs and their respective CSIs to be protected by an SG based upon the templates in step 432. A first SU is created for the SG and then others are copied to create the complete SG. A next set of SIs and CSIs can then be generated for the next SG. If the SIs belong to the same SI template, the SG is just copied, until all the SIs required by the template have been assigned to an SG. For the next SI template the process can be repeated starting with the creation of a first SU. The process ends when all the SGs have been created for all SI templates.

The configuration, e.g., a file, generated by this exemplary process can, for example, be in an IMM XML format for use by an AMF. As mentioned above, the elements of this configuration can be generated by a type matching process which loops on the SI templates: for each SI template the SG type, the SU type and the component types are selected. Exemplary pseudocode illustrating this process in more detail is provided below. For the instance generation described above, there are additional loops as multiple instances are created for each selected type. The configuration, e.g., IMM XML, contains both the entity types and all the generated instances. An additional exemplary step that occurs when an AMF puts this exemplary configuration to use is the step of deployment, i.e., assigning components and such to actual nodes.

Using the above described exemplary embodiments, the AMF Configuration Generator 402 generates a configuration which becomes an output of code in, for example, an IMM XML file 412. This output of an IMM XML file 412 is preferably provided in an acceptable format for use by an AMF system as described in, for example, SAF Software Management Framework (SMF) specification SAI-AIS-SMF-A.01.01. This exemplary code is then stored in a Configuration Repository 310 (or other desirable computer readable medium or memory storage unit) in step 414 for future use by an AMF.

An additional process that occurs at the end of the exemplary generation of an AMF configuration is the method for distribution of the SUs on the cluster nodes. The AMF specification does not currently describe performance characteristics for entities, therefore an exemplary method for distribution of SUs can assume that each SU of the configuration produces equal workloads with respect to each other and with or without assignment. It is at this point that the number of nodes to be used needs to be known by the system as either a received user input or by the system knowing what is available, e.g., information provided by another SAF service. Based on this assumption, this exemplary method distributes the SUs among the nodes of the cluster by selecting for each SU the node that has the smallest load and that has no (or the fewest number of) SUs of the same SG that the current SU belongs to. These conditions can be provided by using a global round robin distribution of the SUs as the SUs are being created during the configuration process. Alternatively, this exemplary distribution method can be modified by assuming, based on performance characteristics of the system, different capacities for the different nodes and different load for the different SUs. Also, another exemplary alternative embodiment for configuration could be based upon the assumption of different failure scenarios desiring to avoid or minimize overload situations when one or more SUs/nodes fail in the system.

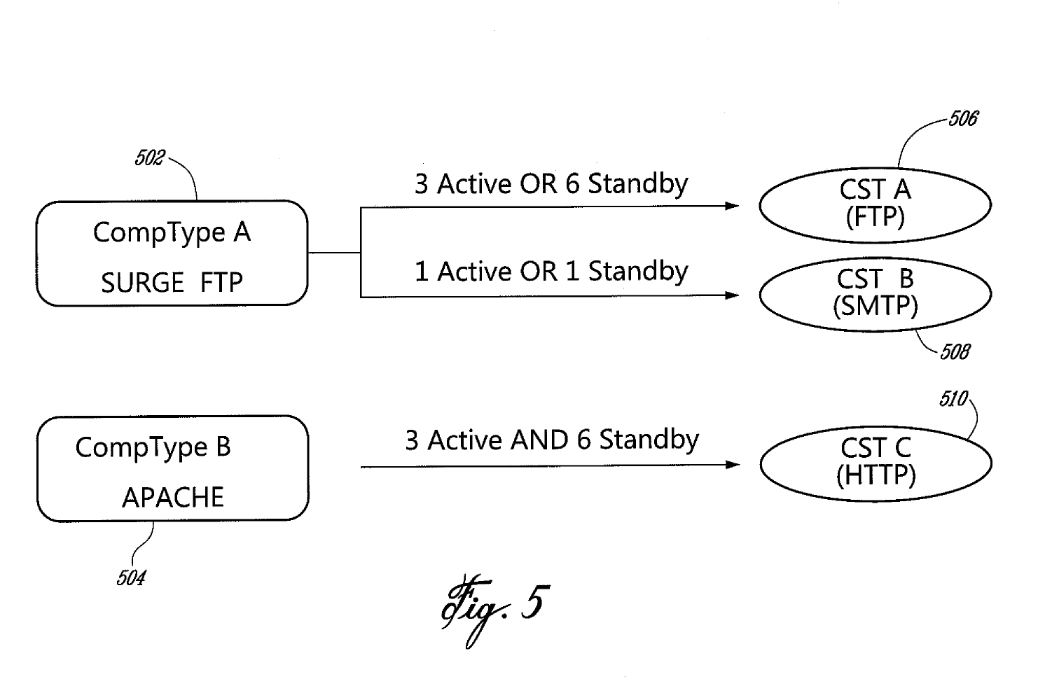

To further illustrate the above described exemplary embodiments for generating an AMF configuration, a purely illustrative exemplary embodiment will now be described with respect to FIGS. 4-10. In this exemplary system, the goal is to support file transfer protocol (FTP) services, simple mail transfer protocol (SMTP) services and hyper text transfer protocol (HTTP) services in an HA environment by creating a configuration file for use by an AMF to manage these services in an HA environment. For the input entity types 404 there are both component types and component service types. As can be seen in FIG. 5, there are two component types labeled CompType A 502 named Surge FTP and CompType B 504 named Apache. CompType A 502 can provide up to three active or six standby assignments for CST As 506 for FTP and, CompType A 502 can also provide up to one active or one standby assignments for CST B 508 for SMTP. Regarding CompType B 504, it is capable of providing up to three active or six standby assignments for CST Cs 510 for HTTP.

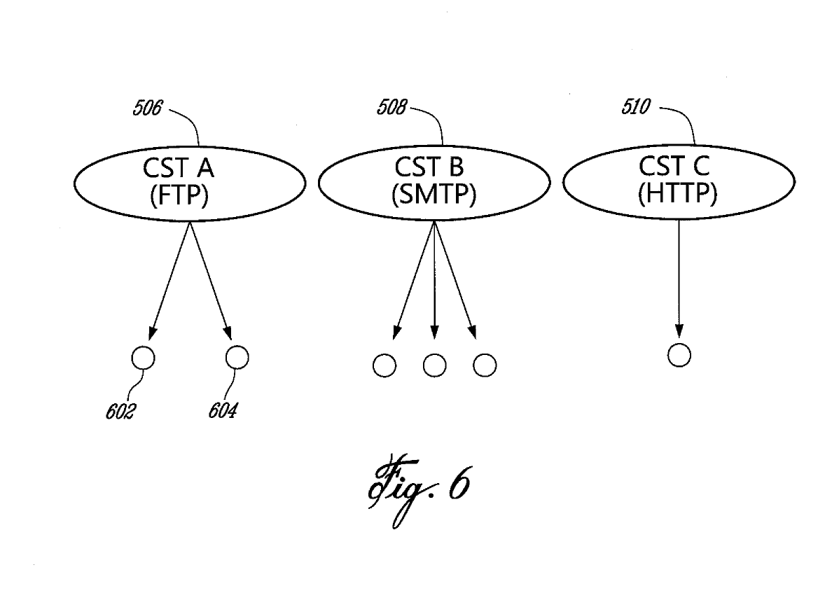

These various CSTs can have a number of different attributes associated with them as shown in FIG. 6. For example, CST A 506 for FTP is shown with two attributes 602 and 604 associated therewith. Attribute 602 could, for example, deal with IP ranges and attribute 604 could, for example, be associated with security levels. More or fewer attributes can be associated with a CST (as well as the other CSTs) as shown by CST B 508 for SMTP having three attributes and CST C 510 having just one attribute. These attributes associated with the CSTs are typically submitted as part of the input entity types 404 as they are determined by the way the software is implemented.

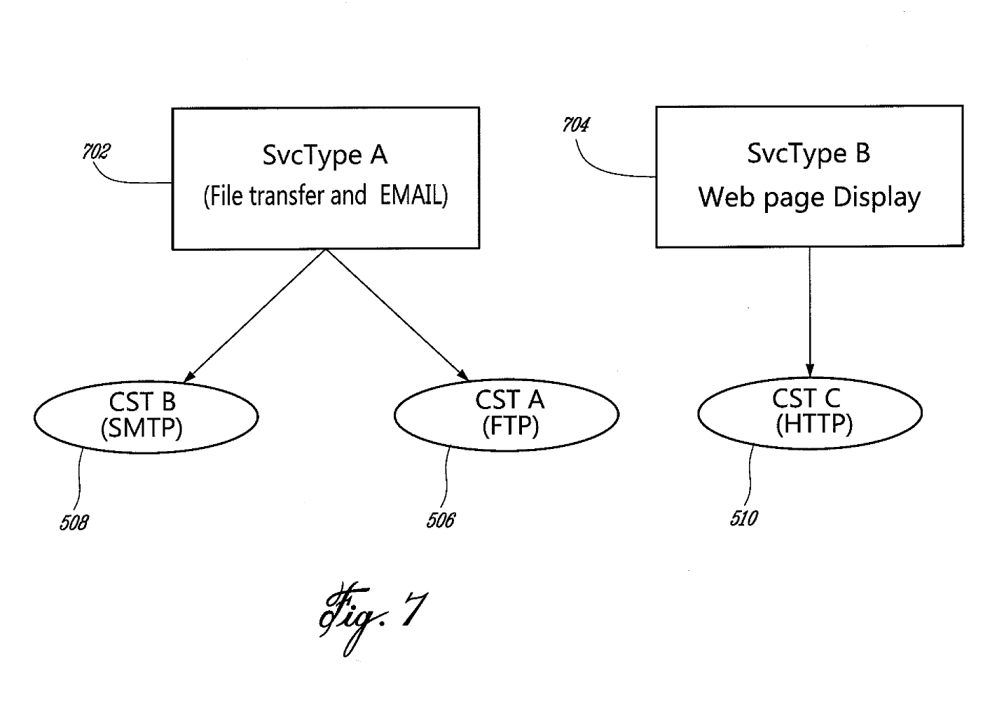

CSTs are also associated with service types. For example, as shown in FIG. 7, two service types are shown, SvcType A 702 representing the file transfers and email service and SvcType B 704 which represents the web page display service. Accordingly, SvcType A 702 is associated with CST B 508 and CST A 506 representing the FTP and SMTP component service types. SvcType B is solely associated with CST C 510, with HTTP. These service types can be submitted as either entity types inputs 404 or as part of the services set/user input 406. This then leads to the various templates submitted as part of the services set/user input 406.

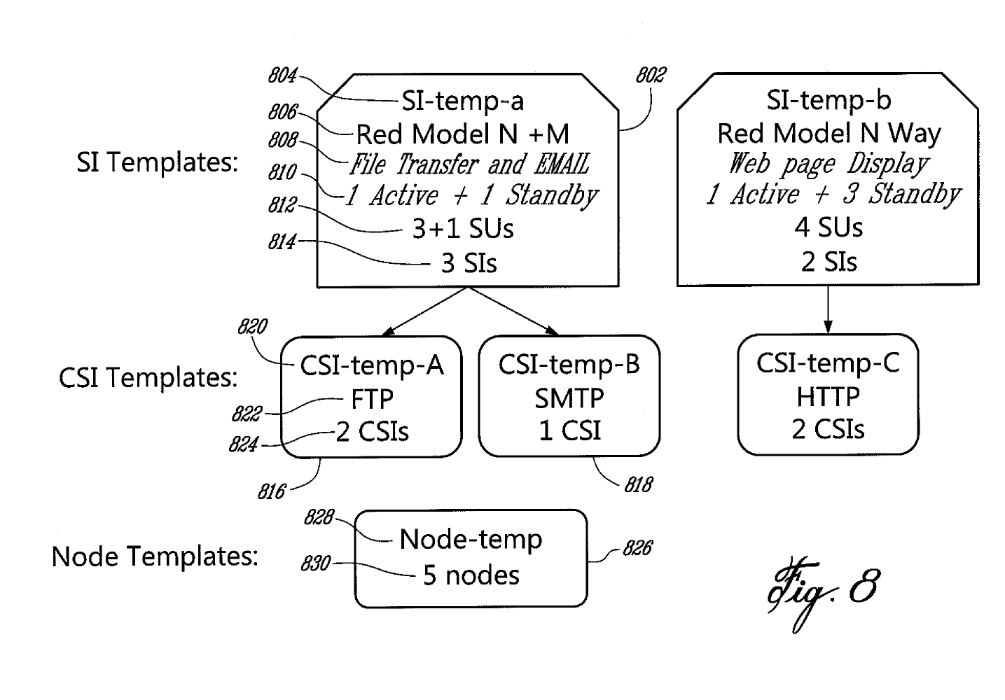

According to exemplary embodiments, the services set/user input 406 includes templates. Continuing with the current example, SI templates, CSI templates and a node template are illustrated in FIG. 8. An SI template 802 includes the following: a name, e.g., SI-temp-a 804; a redundancy model, e.g., N+M 806; a service type, e.g., File Transfer and Mail 808; the preferred number of active and standby assignments per SI, e.g., 1 Active+1 Standby 810; the values for N and M SUs as appropriate for the redundancy model, e.g., 3+1 SUs 812; and the desired number of SIs, e.g., 3 SIs. Associated with each SI template 802 are one or more CSI Templates 816 and 818. CSI template 816 includes a name, e.g., CSI-temp-A 820, a CST, e.g., FTP 822, and the number of CSIs in this case one 824. The other template is a node template 826 which includes a name 828 and the number of nodes to be used 830 for the distribution of the generated service units.

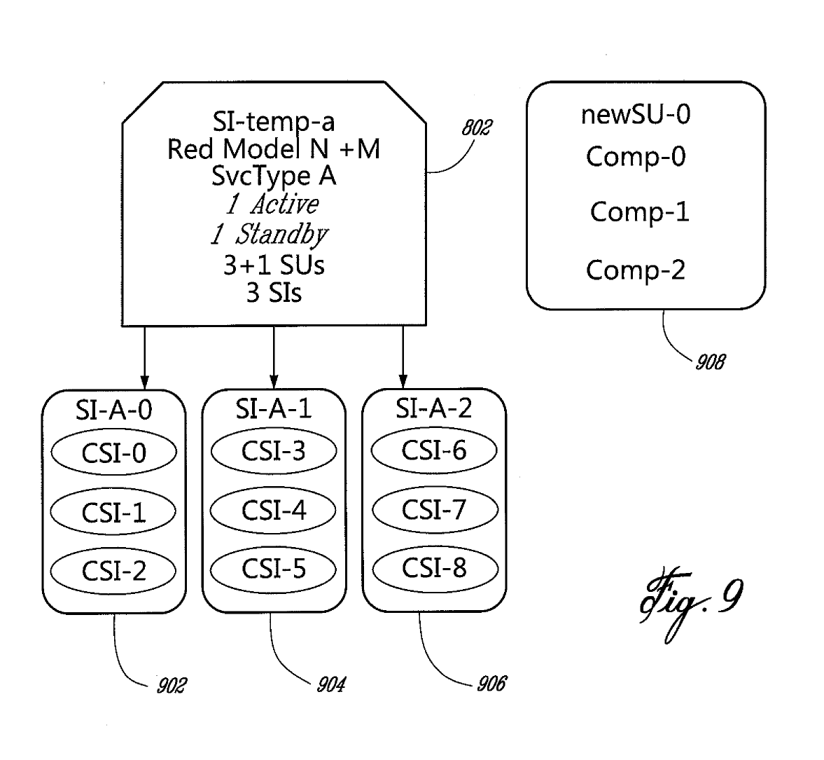

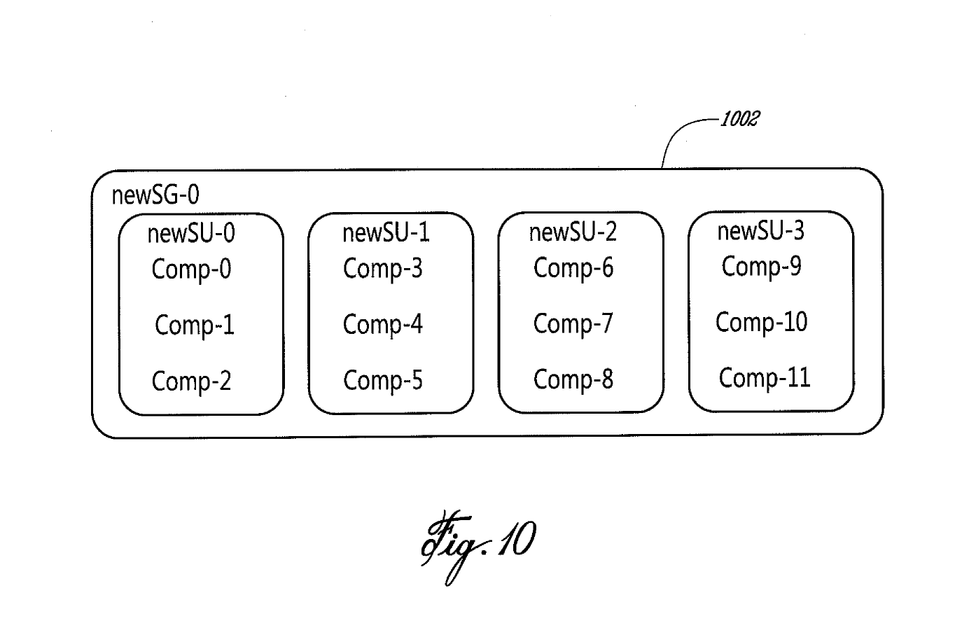

At some point after filling in the desired templates, these desired templates as well as the entity types 404 are processed by the AMF Configuration Generator 402. For example, as shown in FIG. 9, SI template 802 is being processed by the AMF Configuration Generator 402. Using the received inputs as well as other known information, such as specified constraints for an AMF, outputs are generated by the AMF Configuration Generator 402. In this case, populated SIs 902, 904 and 906 are generated. Additionally, in this example, a first SU 908 is created of a new SU type to meet the desired needs associated with the SIs since there was no acceptable, available SU type and the user input allowed for the creation of new SU type as needed. Also, the Configuration Generator 402 determined that the best CompType for CST A and CST B is CompType A which allows the SU 908 to only use three components. Each of the SIs 902, 904 and 906 have three CSIs associated with them to support setup. To meet another need as specified by the user input, e.g., the provision of three active SUs and one standby SU 812, four SUs are created and deployed as shown in FIG. 10 as part of the new SG 1002.

According to exemplary embodiments, illustrative pseudo-code used for generating an AMF configuration is shown below. This illustrative pseudo-code is broken down into three sections: Inputs, Outputs and Configuration Generation, for ease of understanding. The Inputs section of pseudo-code corresponds to the various inputs that may be received by the AMF Configuration Generator 402. Some of them are mandatory (e.g. component type, component service type, SI templates), others may be generated by the configuration generator (e.g. SU type). The Outputs are building blocks of the final configuration created from the Inputs by the Configuration Generation. The Outputs together with some of the Inputs presented to an AMF implementation via IMM in an XML file providing this way the complete AMF information model.

### INPUTS

The first group of inputs described are from the entity types 404 subset. A component service type is a set as described by
cst={attᵢ; 0<=i<|cst|, any number of attributes}.
   All component service types compose the set
CST={cstᵢ; 0<=i<|CST|}.
   A component capability, which is used in describing a component type, is described by a tuple of
csCapability=<cst, compCap, maxAct, maxStdb>, where
cst ε CST;

$$compCap = \{ \begin{matrix}x\_active \_and \_y \_standby \\ x\_active \_or \_y \_standby \\ I\_active \_or \_y \_standby \\ I\_active \_or \_I \_standby \\ x\_active \\ I\_active\end{matrix} \\ maxAct = \{ \begin{matrix}x\_active \_and \_y \_standby ⇒ x , x \geq 1 \\ x\_active \_or \_y \_standby ⇒ x , x \geq 2 \\ I\_active \_or \_y \_standby ⇒ 1 \\ I\_active \_or \_I \_standby ⇒ 1 \\ x\_active ⇒ x , x \geq 2 \\ I\_active ⇒ 1\end{matrix} \\ maxStdb = \{ \begin{matrix}x\_active \_and \_y \_standby ⇒ y , y \geq 1 \\ x\_active \_or \_y \_standby ⇒ y , y \geq 1 \\ I\_active \_or \_y \_standby ⇒ y , y \geq 2 \\ I\_active \_or \_I \_standby ⇒ 1 \\ x\_active ⇒ 0 \\ I\_active ⇒ 0\end{matrix}$$

A component type can be described as a set as follows.
ct={csCcapabilityᵢ; 0<=i<|ct″, all the component service (CS) types provided by the component type ct}
   All component types compose the set as described by
CT={ctᵢ; 0<=i<|CT|}.

A second type of inputs may belong either to the entity types 404 or to the services set/user input 406 subset.

A member CS type is a tuple as described by
memCst=<cst, maxCsi>, where
cst ε CST;
maxCsi is the number of CSIs of type cst that a service instance of a particular type may contain.
   A service type is a set
st={memCstᵢ; 0<=i<|st| component service instances that compose the service type st}.
   All the service types compose the set
ST={stᵢ; 0<=i<|ST|}. .

A third type of inputs may belong either to the entity types 404 or to the services set/user input 406 subset or completely omitted as an input. In this latter case the configuration generation is creating these types.

### Service Unit Types

The services of a service unit type is a set as described by sutServices={stᵢ; 0<=i<″sutServices|, all the service types the service unit provides and it is a subset of ST}

A member component type is a tuple
memCt=<ct, maxComp>where
ct ε CT;
maxComp is the maximum number of instances of this component type an SU of this type may contain.
   The component types of an SU type is a set
sutCt={memCtᵢ; 0<=i<|sutCt|, all the component types the service unit may contain and |sutct|<=|CT|}.
   A service unit type is a tuple
sut=<sutCt, sutServices>
   All the service unit type compose the set
SUT={sutᵢ; 0<=i<|SUT|}
   This set may be empty (SUT={}) at the beginning of the configuration generation.

### Service Group Types

The service unit types of a service group type is a set as described by sgtSut={sutᵢ; 0<=i<|sgtSut|, all the service unit types the service group may contain and it is a subset of SUT}

A service group type is a tuple
sgt=<sgtSut, redMod>, where

$$redMod = \{ \begin{matrix}2 n \\ nplusm \\ nway \\ nwayactive \\ noredundancy\end{matrix}$$

All service group types compose the set
SGT={sgtᵢ;0<=i<|SGT|}
   This set may be empty (SGT={}) at the beginning of the configuration generation.

A third type of inputs is the services set/user input 406 which, as described according to exemplary embodiments above, includes Service Instance templates for the service instances that need to be protected by Service Groups. Pseudo-code for a variety of services set/user input 406 is shown below.

### CSI Templates

A CSI template is a tuple
csiTemp=<cst, numCsi>, where
cst ε CST;
numCsi is the number of CSIs of type cst created based on this template.
   All CSI templates compose the set
CSIT={csiTempᵢ; 0<=i<|CSIT|}.

### SI Templates

A SI template is a tuple
siTemp=<st, sicsTemps, redMod, numSIs, numAct, numStdb, numSUs>, where
st ε ST;
sicsiTemps={csiTemp₁; 0<=i<|sicsiTemps| ∀csiTempᵢ.cst≡stᵢ.cst and csiTempᵢ.numCsi≦stᵢ.maxCsi};
numSIs is the number of SI that is created using this template

$$numAct = \{ \begin{matrix}redMod \neq nwayactive ⇒ 1 \\ x ; x \geq 2\end{matrix}$$

is the number of HA active assignments per SI;

$$numStdb = \{ \begin{matrix}redMod ≡ nway ⇒ y ; y \geq 1 \\ redMod ≡ nwayactive ⇒ 0 \\ redMod ≡ noredundancy ⇒ 0 \\ 1\end{matrix} , is the number of HA standby$$

assignments per SI;
numSUs=<sus, susAct, susStdb,susSpare>, where
sus the total number of SUs in the SG protecting the Sis generated from this template; sus=susAct+susStdb+susSpare;

$$numAct = \{ \begin{matrix}redMod ≡ nplusm ⇒ z \\ redMod ≡ nwayactive ⇒ z ; z > 1 \\ redMod ≡ noredundancy ⇒ numSIs \\ redMod ≡ 2 n ⇒ 1 \\ redMod ≡ nway ⇒ 0\end{matrix} , is the number of SUs that can have$$

only active assignments;

$$susStbd numStdb = \{ \begin{matrix}redMod ≡ nplusm ⇒ w \\ redMod ≡ nwayactive ⇒ 0 \\ redMod ≡ noredundancy ⇒ 0 \\ redMod ≡ 2 n ⇒ 1 \\ redMod ≡ nway ⇒ 0\end{matrix} is the number of SUs that can$$

have only standby assignments;
susSpare is the number of spare SUs.
   All SI templates compose the set
SIT=tsiTempᵢ; 0<=i<|SIT|}.

The final type of input is the number of nodes. Number of nodes can be an optional separate input, or defined elsewhere, e.g., as part of an SI template. The number of nodes can be described using pseudo-code as a node template as follows.

The node template is a tuple
nodeTemp=<numNodes>, where
numNodes is the number of nodes created based on the template.
   All node templates compose the set
NodeTemp={nodeTempᵢ; 0<=i<|NodeTemp|}.

Outputs are a result of processing by the AMF Configuration Generator 402 to be used in the final configuration file. The pseudo-code used to describe and generate these Outputs is described below.

### Outputs

### Components

A component has a name and belongs to component type. It is a tuple
comp=<safComp, ct>, where
ct ε CT;
safComp is a tuple safComp=<safsu, rdn>, where
safsu is a SAF compliant LDAP distinguished name of the SU the component belongs to and
rdn is a relative distinguished name of the component, which is unique within the SU.

### Service Units

A service unit is a tuple
su=<safsu, sut, memComps>, where
safsu is a tuple safsu=<safsg, rdn>, where
safsg is a SAF compliant LDAP distinguished name of the SG the service unit belongs to and
rdn is a relative distinguished name of the SU which is unique within the SG;
sut ε SUT;
memComps={memCompᵢ; 0<=i<|memComps|,
∀memComp.safComp.safSu≡safSu;}
memComp={} at the start of the configuration generation.

### Service Groups

A service group is a tuple
sg=<safSg, sgt, memSus, nodeGroup>, where
safSg is a tuple safSg=<safApp, rdn>, where
safApp is a SAF compliant LDAP distinguished name of the application the service group belongs to. and
rdn is a relative distinguished name of the SG, which is unique within the application;
sgt ε SGT;
memSus={memSuᵢ; 0<=i<|memSus|, memSuᵢ.sut ε sgt.sgtSut and
∀memSu.safSu.safSg≡safSg;}
memSUs={} at the start of the configuration generation
nodeGroup={nodeᵢ; 0<=i<|nodeGroup|,}); the nodeGroup ⊂ Cluster on which the SG is distributed.

### Component Service Instances

A component service instance is a tuple
csi=<safCsi, cst, attrValues>, where
safCsi is a tuple safCsi=<safSi, rdn>, where
safSi is a SAF compliant LDAP distinguished name of the service instance the component service instance belongs to, and
rdn is a relative distinguished name of the CSI, which is unique within the service instance;
cst ε CST;
attrValues={attrValueᵢ; 0<=i<|cstp|}
attrValue=<attr, value>, where
∀attrValue.attr ε cst.attr;
attrValue.value is a value set for the attribute
attrValues={} the method does not currently include the generation of attribute values.

### Service Instances

A service instance is a tuple
si=<safSi, st, sg, memCsis>, where
safSi is a tuple safSi=<safApp, rdn>, where
safApp is a SAF compliant LDAP distinguished name of the application the service instance belongs to, and
rdn is a relative distinguished name of the Si, which is unique within the application;
st ε ST;
memCsis={memCsᵢ; 0<=i<|memCsis|, ∀memCsi.cst [symbol] ∃.st.cst; and
∀memCsi.safCsi.safSi≡safSi;}
memCsis={}at the start of the configuration generation
sgSis={siᵢ; 0<=i<|sgSis|, ∀siᵢ.sg≡sg} the set of SIs protected by the same service group, they specify the same service group.

### Application

The application for which the configuration is generated is a tuple
app=<safApp, memSgs, memSis>, where
safApp is a distinguished name of the application;
memSgs={memSgᵢ; 0<=i<|memSgs|, ∀memSg.safSg.safApp≡safApp;} memSgs={} at the start of the configuration generation.
memSis={memSiᵢ; 0<=i<|memSis|, ∀memSi.safSi.safApp≡safApp;}
memSis={} at the start of the configuration generation.

### Nodes

node=<safAmfNode, hostedSus>, where
safAmfNode is a distinguished name of the node;
hostedSus={hostedSuᵢ; 0<=i <|hostedSus|}
hostedSus={}at the start of the configuration generation.
   All nodes compose the cluster:
Cluster={nodeᵢ; 0<=i<|Cluster|}

findCompType Method

### Input

sut, the service unit type within which the search is performed, it may be empty
cst, the component service type that needs to be provided
redMod, the redundancy model within which cst is provided

### Output

chosenCompType, the selected component type

### Functional Description

The find CompType method selects the component type within the service unit type or among all component types that can provide the highest utilization for the given redundancy model.
validCompTypes is the set of component types that can provide a required component service type cst within the service unit type sut or among all the component types:

$$validCompTypes = \{ {vct}_{i} ; \{ \begin{matrix}sut \neq \{ \} ⇒ ∀ sut . {sutCt}_{j} . {csCapability}_{k} . cst ≡ cst ⇒ {vct}_{i} \\ sut ≡ \{ \} ⇒ ∀ {ct}_{j} . csCapability . cst ≡ cst ⇒ {vct}_{i}\end{matrix} , \\ {ct}_{i} ∈ CT .$$

```
begin
MaxMin = 0
chosenCompType = { }
i = 0
while (i < |validCompTypes|) // for each valid component type vct
begin
  j = 0
  while (j < |vctᵢ.csCapability|) // for each CS type it provides
  begin
    if redMod == 2n OR redMod == nplusm
      Min = min(vctᵢ.csCapabilityⱼ.maxAct,
vctᵢ.csCapabilityⱼ.maxStandby)
    if redMod == nway
      // x_active_and_y_stanby is the mandatory capability for
nway
      if vctᵢ.csCapabilityⱼ == x_active_and_y_standby
        Min=min(vctᵢ.csCapabilityⱼ.maxAct,
vctᵢ.csCapabilityⱼ.maxStandby)
      else
        Min = 0 // cannot be used for nway
    if redMod == nwayactive OR redMod == noredundancy
      Min= vctᵢ.csCapabilityⱼ.maxAct
    if Min > 0 AND Min > MaxMin
    begin
      MaxMin = Min
      chosenCompType = ctᵢ
    end
    j = j + 1
  end
  i = i + 1
end
if chosenCompType == { }
  return cst cannot be provided
else
  return chosenCompType
end
```

suActCap Methods

### Input

siTemp, an SI template

### Output

suActCap, the required active capability for the SU type or an SU with respect to the SI template

### Functional Description

The required SU active capabilities are calculated with respect to the SI template with the assumption that an SU provides a group of Sis from a single template. In the formula ceil( ) is used to round up to the nearest integer.

### Return

$$suActCap = \{ \begin{matrix}redMod ≡ nway ⇒ ceil ( \frac{siTemp . numSIs}{\begin{matrix}siTemp . numSUs . sus - \\ siTemp . numSUs . susSpare\end{matrix}} ) \\ redMod ≡ nwayactive ⇒ ceil ( \frac{siTemp . numSIs \times siTemp . numAct}{siTemp . numSUs . susAct} ) \\ redMod ≡ noredundancy ⇒ siTemp . numSIs \\ redMod ≡ 2 n ⇒ siTemp . numSIs \\ redMod ≡ nplusm ⇒ ceil ( \frac{siTemp . numSIs}{siTemp . numSUs . susAct} )\end{matrix}$$

suStdbCap Methods

### Input

siTemp, an SI template

### Output

suStdbCap, the required standby capability for the SU type or an SU with respect to the SI template

### Function Description

The required SU standby capabilities are calculated with respect to the SI template with the assumption that an SU provides a group of Sis from a single template. In the formula ceil( ) is used to round up to the nearest integer.

### Return

$$suStdbCap = \{ \begin{matrix}redMod ≡ nway ⇒ ceil ( \frac{\begin{matrix}siTemp . numSIs \times \\ siTemp . numStdb\end{matrix}}{\begin{matrix}siTemp . numSUs . sus - \\ sitemp . numSUs . susSpare\end{matrix}} ) \\ redMod ≡ nwayactive ⇒ 0 \\ redMod ≡ noredundancy ⇒ 0 \\ redMod ≡ 2 n ⇒ siTemp . numSIs \\ redMod ≡ nplusm ⇒ ceil ( \frac{sitemp . numSIs}{siTemp . numSUs . susStdb} )\end{matrix}$$

findSUType Method

### Input

siTemp, an SI template

### Output

chosenSuType, the selected service unit type

### Functional Description

This function searches for the first SU type that can provide the Sis of the given template siTemp. Optimization may be added depending on other requirements. validSuTypes is the set of service unit types that can provide the required service type siTemp.st among all the service unit types:

$$validSuTypes = \{ {vsut}_{i} ; SUT \neq \{ \} \{ \begin{matrix}siTemp . redMod \neq nway ⇒ ∀ {sut}_{j} . st ≡ siTemp . st ⇒ {vsut}_{i} \\ siTemp . redMod ≡ nway ⇒ \\ ⇒ ∀ {sut}_{j} . memCt . csCapability . compCap ≡ x\_active \_and \_y \_stanby ⋀ \\ ⋀ ∀ {sut}_{j} . st ≡ siTemp . st ⇒ {vsut}_{i}\end{matrix}$$

It may be an empty, set in which case a new SU type is created if it is permitted by limited.

```
begin
chosenSuType = { }
if validSuTypes ≠ { }
begin
  i = 0
  while(i < |validSUTypes|) // find an SU type that
  begin
    j = 0
    while(j < |siTemp.sicsiTemp|) // supports all CSI templates
    begin
      // use findCompType to find an appropriate component
      if
NOT(
∃k, l [symbol] siTemp.csiTempⱼ.cst ≡ vsutᵢ.memCtₖ.csCapabilityₗ.cst
)
        j = j + |siTemp.sicsiTemp| // make it break by being too
big
      else
        if ((vsutᵢ.memCtₖ.csCapabilityₗ.maxAct x
            x vsutᵢ.memCtₖ.csCapabilityₗ.maxComp) <
            < (siTemp.csiTempⱼ.numCsi x
suActCap(siTemp))) OR
          ((vsutᵢ.memCtₖ.csCapabilityₗ.maxStdb
            x vsutᵢ.memCtₖ.csCapabilityₗ.maxComp) <
            < (siTemp.csiTempⱼ.numCsi x
suStdbCap(siTemp)))
          j = j + |siTemp.sicsiTemp| // make it break by being
too big
      j = j + 1
    end
    // next condition is only true if break occurred, if so go for next
SU type
    if j > |siTemp.sicsiTemp|
      i = i + 1
    else
    begin
      chosenSuType = vsutᵢ
      return chosenSuType // returns the first appropriate SU
type
    end
  end
end
if chosenSuType == { }  // if nothing is found or no valid SU types
begin
  chosenSuType = <{ }, siTemp.st>  // create a new SU type
  i = 0
  while(i < |siTemp.sicsiTemp|) // that supports all CSI templates
  begin
    vct = { }
    vct = findCompType(chosenSuType,
siTemp.csiTempᵢ.cst,siTemp.redMod)
    if vct == { }
      return { } // cst cannot be provided
    if vct ∉ sut.sutCt
      chosenSuType.sutCt = chosenSuType.sutCt U {<vct,
NoLimit>}
    i = i + 1
  end
  SUT = SUT U { chosenSuType }
  return chosenSuType
end
end
```

findSGType Method

### Input

sut, an SU type
redMod, the required redundancy model

### Output

chosenSgType, the selected service group type

### Functional Description

This function searches for the first SG type that can protect the Sis using the requested service unit type sut according to the requested redundancy model redMod. Optimization may be added depending on other requirements.

```
begin
chosenSgType = { }
i = 0
while(i < |SGT|)
begin
  // the SG type allows for the SU type and the redundancy model
  if sgtᵢ.redMod == redMod AND ∃k [symbol] sgtᵢ.sutₖ ≡ sut
  begin
    chosenSgType = sgtᵢ
    return chosenSgType
  end
  i = i + 1
end
if chosenSgType == { }
begin
  chosenSgType = <sut, redMod>
  SGT = SGT U { chosenSgType }
  return chosenSgType
end
end
```

createSis Method

### Input

siTemp, an SI template for which the SIs are being generated
sg, the sg that shall protect this set of SIs

### Output

sgSis, the set of service instances protected by a service group

### Functional Description

Based on the provided SI template, this method generates all the service instances and their component service instances that shall be protected by a service group. Currently this function does not include the generation of CSI attributes.

```
begin
sgSis = { }
i = 0
while(i < |siTemp.numSIs|)
begin
  si = <”safSi=...”, siTemp.st, sg, { } >
  j = 0
  while (j < |siTemp.sicsiTemps|) // for each CS type in the SI
  begin
    k = 0
    while (k < |siTemp.csiTempⱼ.numCsi|)
    // create the specified number of CSIs
    begin
      si.memCsis = si.memCsis U {<”safCsi=...”,
siTemp.csiTempⱼ.cst, { } >}
      k = k + 1
    end
    j = j + 1
  end
  sgSis = sgSis U {si}
  i = i + 1
end
return sgSis
end
```

Final configuration generation will now be described using the pseudo-code as described below.

generateConf Method

### Input

CT all component types
CST all component service types
ST all service types
SIT all service instance templates
CSIT all component service instance templates
SUT service unit types, may be empty
SGT service group types, may be empty
nodeTemp the node template
userPreference is a set of preferences that guides the configuration generation. They allow for different options and optimization and can be extended accordingly. The pseudo-code does not reflect them.

### Output

AMF entities for a single application distributed on the nodes of a cluster, i.e. app=<safApp, memSgs, memSis>. Since the application refers to the SG set and the SI set, and they all refer to their children in turn, only the application itself is defined in this example as an output. This “app” is thus a tree with all the instances according to the Output section.

### Functional Description

This is the main function which, after determining the required entity types using the findSUType and findSGType methods, populates the configuration with all the instances listed as outputs. It also distributes the generated service units on the nodes.

begin

app = < “safApp= . . . ”, { }, { }> // create an application instance of

the output

i = 0
m = 0
while(i < |SIT|) // for each SI template
begin

sut = { }
sut = findSUType(siTempᵢ) // find appropriate SU type
if sut == { }

return // no configuration can be generated

sgt = { }
sgt = findSGType(sut, siTempᵢ.redMod) // find appropriate SG

type

sg = < “safSg= . . . ”, sgt, { }, { }, { } > // a first SG instance of the

output set is created

app.memSis = createSis(siTempᵢ, sg) // create the protected

SIs instances and assigned them to that SG instance

// create first SU in the SG
su = < “safSu= . . . ”, sut, { } >
sg.memSus = su.memSus U {su}
sg.nodeGroup = sg.nodeGroup U {nodeₘ}
nodeₘ.hostedSus = nodeₘ.hostedSus U {su}
m = (m + 1) mod |Cluster|
j = 0
ct_set = { } // component types in use
su_act = suActCap(siTempᵢ)
su_stdb = suStdbCap(siTempᵢ)
while(j < |siTempᵢ.sicsiTemps|) // for all CS types
begin

ct = findComType(sut, siTempᵢ.csiTempⱼ.cst,

siTempᵢ.redMod)

$N = max ( ceil ( \frac{su\_act \times {siTemp}_{i} . {csiTemp}_{j} . numCsi}{ct . csCapability . max Act} ) , \\ ceil ( \frac{su\_act \times {siTemp}_{i} . {csiTemp}_{j} . numCsi}{ct . csCapability . max Stdb} ) )$

mem_ct = <ct, N> // number of instances of a component

type

if mem_ct ∉ Ct_set
begin

ct_set = ct_set U {mem_ct} // remember the number of

instances

k = 0
while (k < N)
// create the needed number of components
begin

su.memComps = su.memComps U {<“safComp = . . . ”,

ct >} // components are created and added to the first SU

k = k + 1

end

end
else
begin

// find how many components are now in the SU
∃/ [symbol] mem_ctₗ.ct≡ct,mem_ctₗ ∈ ct_set
if mem_ctₗ.N < N // if not enough
begin

k = 0
while (k < N − mem_ctₗ.N)
// create the needed number of components
begin

su.memComps = su.memComps U {<“safComp

= . . . ”, ct >}

k = k + 1

end
mem_ctₗ.N = N

end

end
j = j + 1

end
k = 1
while (k < siTempᵢ.numSus.sus)
// clone the needed number of SUs
begin

new_su = <“safSu= . . . ”, su.sut, su.memComps>
sg.memSus = su.memSus U {new_su} //second, third

etc. SUs are created and added to the SG

k = k + 1
sg.nodeGroup = sg.nodeGroup U {nodeₘ}
nodeₘ.hostedSus = nodeₘ.hostedSus U {su}
m = (m + 1) mod |Cluster|

end
app.memSgs = app.memSgs U {sg} //the SG is added to the

application

i = i + 1

end

end

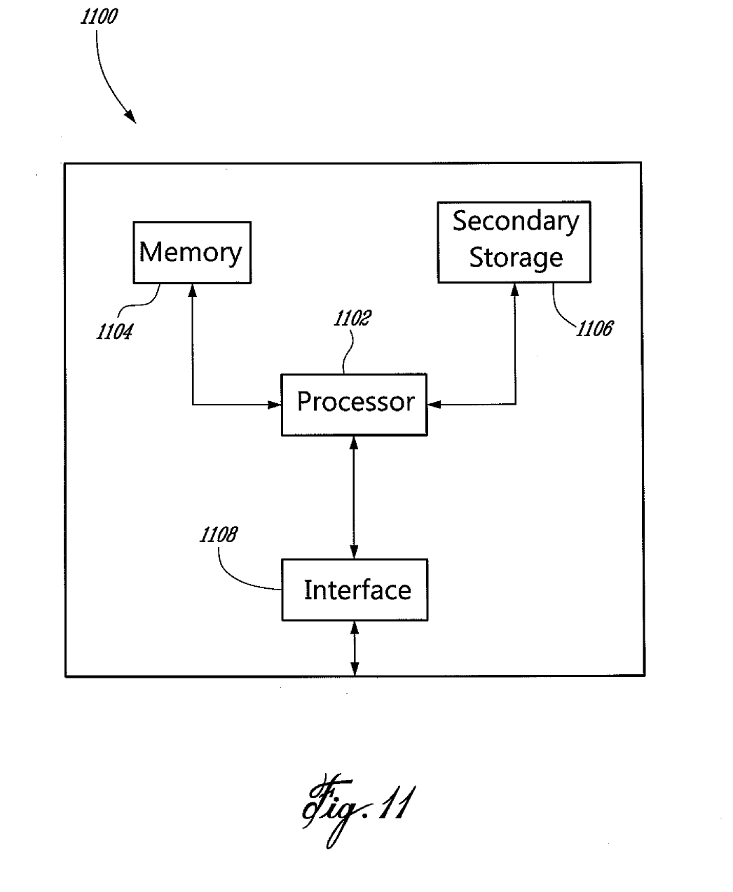

The exemplary embodiments described above provide methods and systems for generating an output of code for an IMM XML file 412 by an AMF Configuration Generator 402 for use by an AMF, typically in a HA environment. An exemplary node 1100 which can act as an AMF Configuration Generator 402 will now be described with respect to FIG. 11. Node 1100 can contain a processor 1102 (or multiple processor cores), memory 1104, one or more secondary storage devices 1106 and an interface unit 1108 to facilitate communications between network node 1100 and the rest of the network, i.e., sources of input and receiver of the output. Additionally, the node 1100 can contain control instructions for automating the generation of the system model based upon received inputs. The memory (or the secondary storage) can be used for storage of exemplary inputs such as user inputs or known required entity types 404 as defined by current AMF standards. Thus, a node 1100 according to an exemplary embodiment may include a processor for generating a system model in the format of an IMM XML schema for future (or current) use by an AMF.

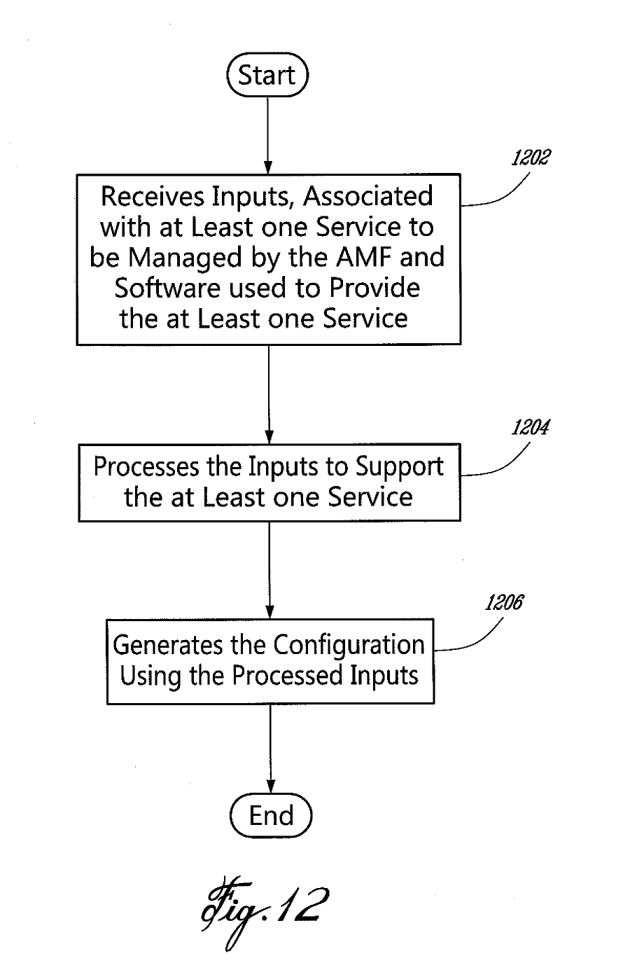

Utilizing the above-described exemplary systems according to exemplary embodiments, a method for generating a configuration file is shown in the flowchart of FIG. 12. Initially a node receives inputs, associated with at least one service to be managed by the AMF and software used to provide the at least one service in step 1202. The node then processes the inputs to support the at least one service in step 1204. The node then generates a configuration using the processed inputs in step 1206.

It will be appreciated that the foregoing exemplary embodiments are merely illustrative and that numerous variations and permutations thereof are within the scope of this document. For example, although the configuration generated by these exemplary embodiments is described as an IMM XML, it will be appreciated by those skilled in the art that this is the input format for IMM, and not necessarily that which is provided directly to an AMF implementation. An AMF implementation may instead have other, non-standard input formats. The configuration which is generated by these exemplary embodiments may be presented in such format(s).

The foregoing description of exemplary embodiments of the present invention provides illustration and description, but it is not intended to be exhaustive or to limit the invention to the precise form disclosed. Modifications and variations are possible in light of the above teachings or may be acquired from practice of the invention. The following claims and their equivalents define the scope of the invention.

1. A method for generating a configuration for an Availability Management Framework (AMF) comprising:
receiving inputs, associated with:
(a) at least one service to be managed by said AMF, and
(b) software used to provide said at least one service;
processing said inputs to support said at least one service; and
generating said configuration using said processed inputs.

2. The method of claim 1, wherein said step of processing further comprises:
matching templates with entity types received as said inputs.

3. The method of claim 1, wherein said step of processing further comprises:
finding a component type by selecting said component type within a service unit type or among all component types such that said component type provides a highest utilization for a specified redundancy model.

4. The method of claim 1, wherein said step of processing further comprises:
calculating required active capabilities for a service unit type with respect to a service instance template, wherein said service unit provides a group of service instances from a single template.

5. The method of claim 1, wherein said step of processing further comprises:
calculating required standby capabilities for a service unit type with respect to a service instance template, wherein said service unit provides a group of service instances from a single template.

6. The method of claim 1, wherein said step of processing further comprises:
searching for a first service unit type that can provide service instances based on at least one of:
(a) finding a component type by selecting said component type within a service unit type or among all component types such that said component type provides a highest utilization for a specified redundancy model;
(b) calculating required active capabilities for a service unit type with respect to a service instance template, wherein said service unit provides a group of service instances from a single template; and
(c) calculating required standby capabilities for a service unit type with respect to a service instance template, wherein said service unit provides a group of service instances from a single template.

7. The method of claim 1, wherein said step of processing further comprises:
searching for a first service group type that can protect service instances using a requested service unit type according to a specified redundancy model.

8. The method of claim 1, wherein said step of processing further comprises:
generating a first set of service instances, and respective component service instances, to be protected by a first service group based upon said inputs;
generating a first service unit for said first service group; and
copying said first service unit to generate additional service units for said first service group.

9. The method of claim 8, further comprising:
generating a second set of service instances, and respective component service instances, to be protected by a second service group based upon said inputs; and
generating a second service unit for said second service group;
copying said second service unit to generate additional service units for said second service group.

10. The method of claim 1, wherein said configuration is a file in an Information Model Management (IMM) external Markup Language (XML) format.

11. The method of claim 1, wherein said step of generating a configuration further comprises:
distributing generated service units on nodes.

12. The method of claim 1, wherein said configuration is stored in a configuration repository.

13. The method of claim 1, wherein said service is an email service operating in a high availability (HA) system.

14. The method of claim 1, wherein said inputs include entity types files, service sets and user inputs

15. The method of claim 1, wherein said inputs include at least a number of nodes associated with a system to be monitored by said AMF.

16. The method of claim 1, wherein said inputs include at least a binary flag for allowing creation of service units associated with a system to be monitored by said AMF.

17. A system comprising:
a node for supporting generation of a configuration for an Availability Management Framework (AMF); and
a processor for generating said configuration for an AMF, including performing the functions of:
receiving inputs, associated with:
(a) at least one service to be managed by said AMF, and
(b) software used to provide said at least one service;
processing said inputs to support said at least one service; and
generating said configuration using said processed inputs.

18. The system of claim 17, wherein templates are matched with entity types received as said inputs.

19. The system of claim 17, wherein a component type is found by selecting said component type within a service unit type or among all component types such that said component type provides a highest utilization for a specified redundancy model.

20. The system of claim 17, wherein required active capabilities are calculated for a service unit type with respect to a service instance template, wherein said service unit provides a group of service instances from a single template.

21. The system of claim 17, where in required standby capabilities are calculated for a service unit type with respect to a service instance template, wherein said service unit provides a group of service instances from a single template.

22. The system of claim 17, wherein said function of processing further comprises:
searching for a first service unit type that can provide service instances based on at least one of:
(a) finding a component type by selecting said component type within a service unit type or among all component types such that said component type provides a highest utilization for a specified redundancy model;
(b) calculating required active capabilities for a service unit type with respect to a service instance template, wherein said service unit provides a group of service instances from a single template; and
(c) calculating required standby capabilities for a service unit type with respect to a service instance template, wherein said service unit provides a group of service instances from a single template.

23. The system of claim 17, wherein a first service group type is searched for that can protect service instances using a requested service unit type according to a specified redundancy model.

24. The system of claim 17, further comprising:
a first set of service instances and respective component service instances, to be protected by a first service group based upon said inputs, are generated;
a first service unit for said first service group is generation; and
said first service unit is copied to generate additional service units for said first service group.

25. The system of claim 24, further comprising:
a second set of service instances, and respective component service instances, to be protected by a second service group based upon said inputs, is generated;
a second service unit for said second service group is generated; and
said second service unit is generated to generate additional service units for said second service group.

26. The system of claim 17, wherein said configuration is a file in an Information Model Management (IMM) external Markup Language (XML) format.

27. The system of claim 17, wherein generated service units are distributed on nodes.

28. The system of claim 17, wherein said configuration is stored in a configuration repository.

29. The system of claim 17, where said service is an email service operating in a high availability (HA) system.

30. The system of claim 17, wherein said inputs include entity types files, service sets and user inputs.

31. The system of claim 17, wherein said inputs include at least a number of nodes associated with a system to be monitored by said AMF.

32. The system of claim 17, wherein said inputs include at least a binary flag for allowing creation of service units associated with a system to be monitored by said AMF.

33. The system of claim 17, wherein said node is part of a system managed by said AMF.

34. The system of claim 17, wherein said node is not a part of a system managed by said AMF.

35. A computer-readable medium containing instructions which, when executed on a computer or processor, perform the steps of:
receiving inputs, associated with:
(a) at least one service to be managed by said AMF, and
(b) software used to provide said at least one service;
processing said inputs to support said at least one service; and
generating said configuration using said processed inputs.

36. The computer-readable medium of claim 35, wherein said step of processing further comprises:
matching templates with entity types received as said inputs.

37. The computer-readable medium of claim 35, wherein said step of processing further comprises:
finding a component type by selecting said component type within a service unit type or among all component types such that said component type provides a highest utilization for a specified redundancy model.

38. The computer-readable medium of claim 35, wherein said step of processing further comprises:
calculating required active capabilities for a service unit type with respect to a service instance template, wherein said service unit provides a group of service instances from a single template.

39. The computer-readable medium of claim 35, wherein said step of processing further comprises:
calculating required standby capabilities for a service unit type with respect to a service instance template, wherein said service unit provides a group of service instances from a single template.

40. The computer-readable medium of claim 35, wherein said step of processing further comprises:
searching for a first service unit type that can provide service instances based on at least one of:
(a) finding a component type by selecting said component type within a service unit type or among all component types such that said component type provides a highest utilization for a specified redundancy model;
(b) calculating required active capabilities for a service unit type with respect to a service instance template, wherein said service unit provides a group of service instances from a single template; and
(c) calculating required standby capabilities for a service unit type with respect to a service instance template, wherein said service unit provides a group of service instances from a single template.

41. The computer-readable medium of claim 35, wherein said step of processing further comprises:
searching for a first service group type that can protect service instances using a requested service unit type according to a specified redundancy model.

42. The computer-readable medium of claim 35, wherein said step of processing further comprises:
generating a first set of service instances, and respective component service instances, to be protected by a first service group based upon said inputs;
generating a first service unit for said first service group; and
copying said first service unit to generate additional service units for said first service group.

43. The computer-readable medium of claim 42, further comprising:
generating a second set of service instances, and respective component service instances, to be protected by a second service group based upon said inputs; and
generating a second service unit for said second service group;
copying said second service unit to generate additional service units for said second service group.

44. The computer-readable medium of claim 35, wherein said configuration is a file in an Information Model Management (IMM) external Markup Language (XML) format.

45. The computer-readable medium of claim 35, wherein said step of generating a configuration further comprises:
distributing generated service units on nodes.

46. The computer-readable medium of claim 35, wherein said configuration is stored in a configuration repository.

47. The computer-readable medium of claim 35, wherein said service is an email service operating in a high availability (HA) system.

48. The computer-readable medium of claim 35, wherein said inputs include entity types files, service sets and user inputs

49. The computer-readable medium of claim 35, wherein said inputs include at least a number of nodes associated with a system to be monitored by said AMF.

50. The computer-readable medium of claim 35, wherein said inputs include at least a binary flag for allowing creation of service units associated with a system to be monitored by said AMF.
